(19) United States
(12) Patent Application Publication
(10) Pub. No.: US 2026/0270337 A1
(43) Pub. Date: Sep. 10, 2026

(54) POUCH ASSEMBLY FOR A HANDHELD RADIO

(71) Applicant: MOTOROLA SOLUTIONS, INC., CHICAGO, IL (US)

(72) Inventors: ARUN KRISHNAN, HILBERT (AU); CLAIRE KIERATH, LANGFORD (AU)

(21) Appl. No.: 19/073,068

(22) Filed: Mar. 7, 2025

(51) Int. Cl. H04M 1/04; A45C 11/00; H04B 1/3888

(52) U.S. Cl. CPC H04M 1/04; A45C 11/002; H04B 1/3888

(57) ABSTRACT

A pouch assembly for protectively covering a handheld radio is disclosed. The pouch assembly includes a pouch body having a closed bottom end, an open top end and a sidewall region. A plurality of holes are defined in the pouch body at a respective plurality of locations within the sidewall region. Each hole of the plurality of holes is situated in an upper portion of the sidewall region. A tensionable cord, extending through each of the holes, includes a plurality of cord sections. The cord sections include first, second, third and fourth cord sections, with each of the first, second, third and fourth cord sections configured to engage over a respective one of four corners of a top end of the handheld radio when the handheld radio is fully inserted into the pouch body.

### BACKGROUND

A radio pouch, or carry case, serves as a protective cover for handheld radios. In the case of certain types of handheld radios issued to military personnel (such as, for example, handheld tactical radios) the radio pouch may also be attached to a soldier's vest for hands-free convenience. In combat situations, the handheld radio is typically kept inside the pouch, but it may be frequently removed to change batteries and for easy access during use.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 illustrates a front perspective view of a pouch assembly in accordance with an example embodiment.

FIG. 2 illustrates another front perspective view of the pouch assembly with a tactical radio inserted therein.

FIG. 3 illustrates a rear perspective view of the pouch assembly with the tactical radio inserted therein.

FIG. 4 illustrates a top view of the pouch assembly with the tactical radio inserted therein.

FIG. 5 illustrates a back view of the pouch assembly with the tactical radio inserted therein.

FIG. 6 is a sectional view of the pouch assembly along the line B-B of FIG. 5, with the tactical radio fully inserted into a locked position inside the pouch body.

FIG. 7 is another sectional view of the pouch assembly along the line B-B of FIG. 5, but showing the tactical radio ejected from the locked position inside the pouch body by an ejection strap.

FIG. 8 illustrates another rear perspective view of the pouch assembly with the tactical radio shown in a partly inserted state.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

In a number of conventional designs for radio pouches, elastic shock cords are used to hold handheld radios securely in a pouch. In these designs, the shock cord is looped over the top face of the handheld radio to keep it in place. However, these designs may have potential problems, such as one or more of the following:
Possible over-reliance on the elasticity of the shock cord for clamping the handheld radio down
In high-impact situations, such as jumping, dropping, or crawling, the weight of the handheld radio can stretch the elastic cord, which may cause the handheld radio to come loose and potentially dislodge from its pouch
The shock cord becomes less elastic over time, which may eventually cause the handheld radio to drop out of the pouch if timely replacement of the shock cord is not carried out
The top face of the handheld radio may be cluttered with many connectors and push buttons, and so fitting the shock cord may be challenging, especially when accessories like the handset and antenna are connected to the handheld radio
The top surface of the handheld radio may feature several push buttons, and so a radio user may accidentally place the shock cord on these buttons, which could in turn lead to unintended activation(s)
In the case of handheld radio removal, the shock cords may assume a state where they hang from the pouch, and thus when such a state occurs, the shock cords may be prone to getting tangled or caught.

Thus, there exists a need for an improved pouch assembly for a handheld radio.

In accordance with one example embodiment, there is provided a pouch assembly for protectively covering a handheld radio. The pouch assembly includes a pouch body having a closed bottom end, an open top end and a sidewall region having a length, as measured from the bottom end to the top end between which the sidewall region extends, that is greater than a corresponding length of the handheld radio. A plurality of holes are defined in the pouch body at a respective plurality of locations within the sidewall region. Each hole of the plurality of holes is situated in an upper portion of the sidewall region corresponding to being below the open top end and above a partial height boundary of the sidewall region that is a vertical distance, equaling a length of the handheld radio, away from the bottom end of the pouch body. The pouch assembly also includes a tensionable cord that extends through each of the holes and comprises a plurality of cord sections that include first, second, third and fourth cord sections with each of the first, second, third and fourth cord sections configured to engage over a respective one of four corners of a top end of the handheld radio when the handheld radio is fully inserted into the pouch body.

In accordance with another example embodiment, there is provided a pouch assembly for protectively covering a handheld radio. The pouch assembly includes a pouch body having a closed bottom end, an open top end and a sidewall region. The sidewall region is divided into a front portion, a first side edge portion, a second side edge portion, and a back portion defining a strap slot. The pouch body is configured to surround the handheld radio in either a fully inserted state or a partly inserted state. The pouch assembly also includes an ejection strap having first and second ends. The ejection strap is disposed in the pouch body such that the ejection strap extends from the first end located outside of the pouch body, into an interior of the pouch body, via the strap slot, and down part of the back portion, across the bottom end to attach to the pouch body by way of the second end of the ejection strap. When the handheld radio is in the fully inserted state resting on a portion of the ejection strap immediately above the bottom end of the pouch body, the ejection strap is configured to be pulled by the first end to force the handheld radio upwardly relative to the pouch body and move the handheld radio from the fully inserted state to the partly inserted state.

Each of the above-mentioned embodiments will be discussed in more detail below. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

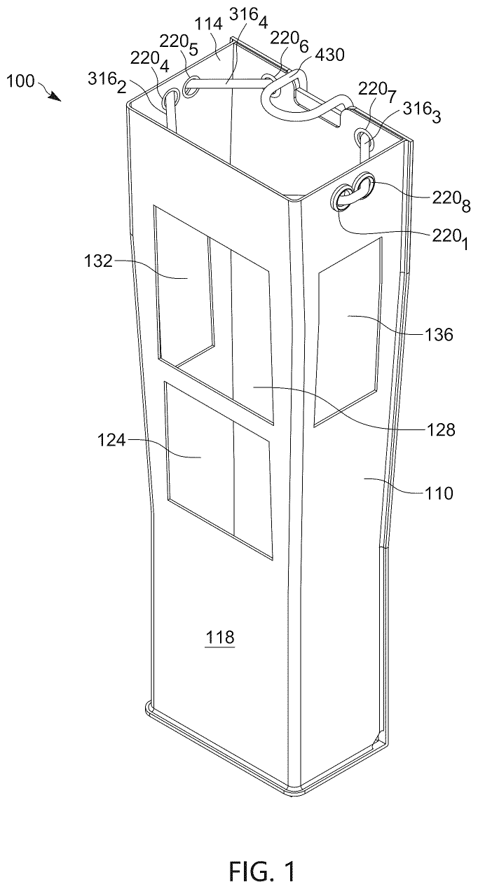

Referring now to the drawings, FIG. 1 illustrates a front perspective view of a pouch assembly 100 in accordance with an example embodiment. The pouch assembly 100 includes a pouch body 110 that includes an open top end 114 and a sidewall region 118. In some examples, the pouch body 110 is a rayon fabric pouch. In alternative examples, the pouch body 110 is made of some other suitable material such as, for instance, heavy-duty nylon.

Defined in the sidewall region 118 are four rectangular-shaped cut-out regions 124, 128, 132 and 136. The number, size, location and shape of these cut-out regions will vary without impacting other aspects of example embodiments.

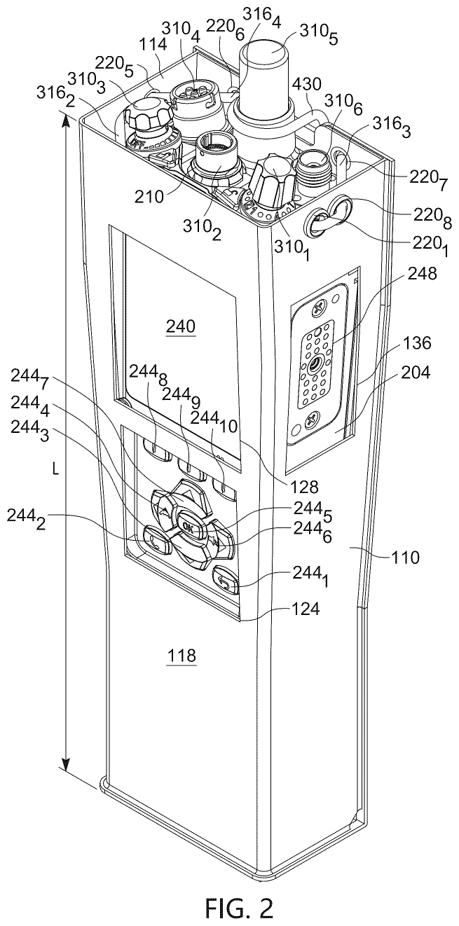

The pouch assembly 100 is designed to receive a handheld radio (such as, for example, tactical radio 204 shown in FIG. 2). A sidewall region having a length “L”, as measured from the bottom end (not visible in FIGS. 1 and 2) to the top end 114 between which the sidewall region 118 extends. This length L is greater than a corresponding length of the handheld radio, such that when the tactical radio 204 is fully inserted into a locked position inside the pouch body 110, a top face 210 of the tactical radio 204 is below both the open top end 114 and a plurality of eyelets 220₁-220₈ that are attached to the pouch body 110 at respective ones of a plurality of holes defined and situated in an upper portion of the sidewall region 118. Besides providing space for the eyelets 220₁-220₈, another impact of having the length L greater than a corresponding length of the handheld radio is that this enables a top part of the pouch body 110 to provide a surrounding guard for connectors, push buttons, etcetera on the top face 210 of the tactical radio 204 when the tactical radio 204 is in the locked position inside the pouch body 110.

When fully inserted into a locked position inside the pouch body 110, the illustrated tactical radio 204 includes areas that are exposed. For example, display screen 240 is exposed by the cut-out region 128, a plurality of input buttons 244₁-244₁₀ are exposed by the cut-out region 124, and a multi-pin connector area 248 is exposed by the cut-out region 136.

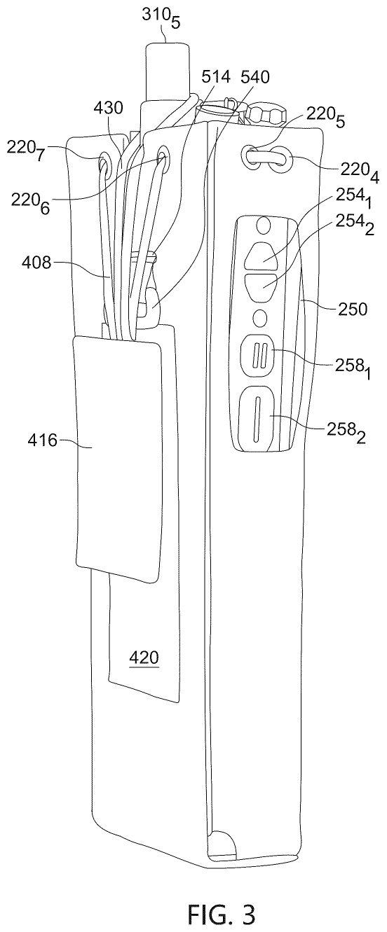

In FIG. 3, which illustrates a rear perspective view of the pouch assembly 100 with the tactical radio 204 inserted into the locked position therein, cut-out region 250 exposes input buttons 254₁ and 254₂, and also exposes input/output port areas 258₁ and 258₂.

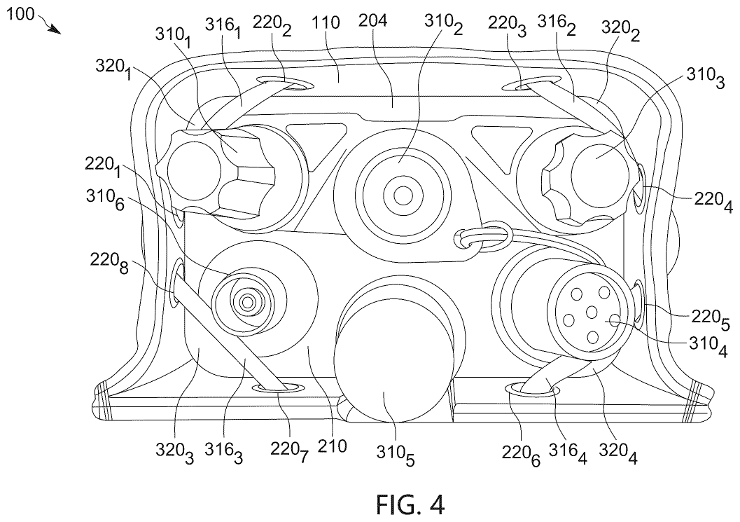

Reference is now made to FIG. 4, which is showing a top view of the pouch assembly 100 with the tactical radio 204 fully inserted into the pouch body 110. Disposed on the top face 210 of the tactical radio 204 are a plurality of radio component protrusions 310₁-310₆. The component protrusions 310₁-310₆ are providing at least some of the following: antenna(s), knob(s), button(s) and connector(s) (for example, one or more antenna connectors or other type of connectors). As will appreciated by those skilled in the art, the number, type and positioning of the antenna(s), knob(s), button(s) and connector(s) will vary depending on the selection of handheld radio to be received into the pouch assembly 100.

Four cord section 316₁-316₄ form a part of a single tensionable cord. This single tensionable cord may be, for example, a shock cord; however, other types of cords (such as, for example, a paracord) may be suitable as well. When a shock cord (or other cord with similar elasticity) is employed, this elasticity is not substantially relied upon to secure the tactical radio 204 inside the pouch body 110. An impact of non-reliance on the elasticity of the tensionable cord may be a longer expected life of the tensionable cord.

When the tactical radio 204 is fully inserted into a locked position inside the pouch body 110, each of the four cord sections 316₁-316₄ extend over a respective one of four top corners of the tactical radio 204. It is also expected that, in the locked position, the four rectangular-shaped cut-out regions 124, 128, 132 and 136 will be aligned with the periphery edges of the areas of the tactical radio 204 intended to be exposed by those cut-out regions.

Further in regards to the four cord sections 316₁-316₄ extending over the corners of the tactical radio 204, the cord section 316₁ extends over corner 320₁ between the eyelet 220₁ and an eyelet 220₂, the cord section 316₂ extends over corner 320₂ between eyelets 220₃ and 220₄, the cord section 316₃ extends over corner 320₃ between eyelets 220₈ and 220₇, and the cord section 316₄ extends over corner 320₄ between an eyelet 220₅ and the eyelet 220₆. Thus, the arrangement of the four cord sections 316₁-316₄ supports engagements with the four corners 320₁-320₄ in a manner to prevent the tactical radio 204 from sliding out of the pouch body 110. As compared to using a whole cord, the comparatively shorter four cord sections 316₁-316₄ in combination with an anchoring effect delivered by the eyelets 220₁-220₈ may act to reduce up-down displacement magnitude of the tactical radio 204 in the pouch body 110 when jarring or other forces (attributable to a person or vehicle moving or being moved) act on the pouch assembly 100. Assuming that each of the four cord sections 316₁-316₄ are engaged with a respective one of the four corners 320₁-320₄, the tactical radio 204 can remain secure in the pouch body 110 even when tensioning of the cord is minimal. Also, an additional impact of engagement with the corners of the tactical radio 204 is that the four corners 320₁-320₄ do not take up significant real estate on the top face 210 of the tactical radio 204. The remainder of the real estate can be occupied by connectors, push buttons, etcetera which are not being interfered with by the four cord sections 316₁-316₄.

As mentioned before, the eyelets 220₁-220₈ are attached to the pouch body 110 at respective ones of a plurality of holes defined and situated in an upper portion of the sidewall region 118. Thus the eyelets 220₁-220₈ of the illustrated example embodiment are strategically positioned so that each corner of the tactical radio 204 is interposed between a respective one of four pairs of the eyelets 220₁-220₈ when the tactical radio 204 is in the locked position within the pouch body 110. Although eyelets are employed in the illustrated example embodiment, other alternatives are contemplated such as, for instance, adding stitching around the hole circumference.

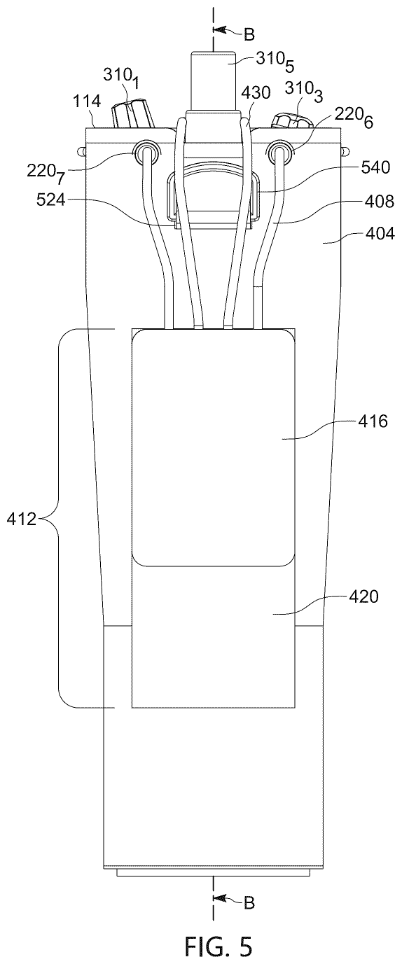

Reference is now made to FIG. 5, which is showing a back portion 404 of the sidewall region 118. Tensionable cord 408 is the same cord discussed previously in connection with FIG. 4, which includes the four cord sections 316₁-316₄. Ends of the tensionable cord 408 are, in the illustrated example embodiment, attached to a hook-and-loop fastener 412 (for example, end sections of the tensionable cord 408 that extend across adjustable pad 416 may be stitched into the adjustable pad 416). The adjustable pad 416 provides, on one side, a hook portion of the hook-and-loop fastener 412. A loop portion 420 of the hook-and-loop fastener 412 is attached on the back portion 404 of the sidewall region 118. The loop portion 420 is elongated, relative to a corresponding dimension of the adjustable pad 416 (and also the hook portion that the adjustable pad 416 provides), to permit a range of different distances and associated variance of tension of the tensionable cord 408. Thus, it will be understood that the adjustable pad 416 is mateable to the loop portion 420 over a range of different distances from the top end 114 according to a desired tension of the tensionable cord 408 (i.e. the lower the adjustable pad 416 is moved, the more any connected cords are tensioned).

Another cord 430 is also shown in FIG. 5. Similar to the tensionable cord 408, the cord 430 may have sections that extend across the adjustable pad 416 similarly stitched into the adjustable pad 416. In the illustrated example embodiment, the cord 430 extends around the radio component protrusion 310₅, which is a radio Global Positioning System (GPS) antenna in the illustrated example embodiment. Also, while the cord 430 is described above as separate from the tensionable cord 408, it is also contemplated that in at least one alternative example that the cord 430 is simply another cord section of the tensionable cord 408.

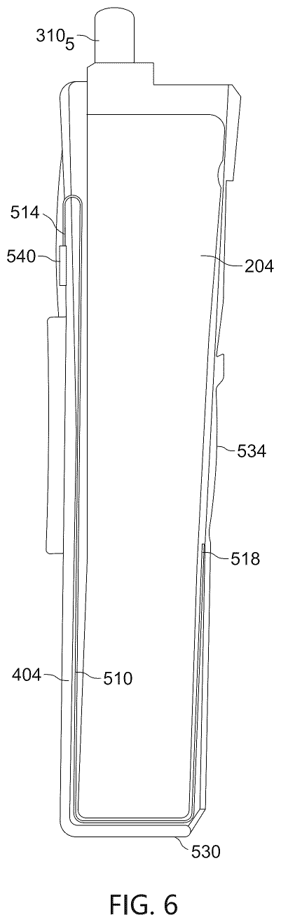

Referring now to FIG. 6, illustrated therein is a sectional view of the pouch assembly 100 along line B-B of FIG. 5.

An ejection strap 510 shown in FIG. 6 has a first end 514 and a second end 518. The illustrated ejection strap 510 is disposed in the pouch body 110 such that the ejection strap 510 extends from the first end 514 located outside of the pouch body 110, into an interior of the pouch body 110, via a strap slot 524 (visible in FIG. 5), and down part of the back portion 404, across a bottom end 530 of the pouch body 110 and upwardly, part-way along a front portion 534 of the sidewall region 118 to fixedly attach via the second end 518 to the front portion 534 of the sidewall region 118. Different locations for where the second end 518 attaches to the pouch body 110 are contemplated. For example, the second end 518 could attach at a higher point on the front portion 534 than illustrated or, for instance, immediately adjacent where the front portion 534 meets the bottom end 530, etcetera.

The fixed attachment of the second end 518 of the ejection strap 510 to the front portion 534 of the sidewall region 118 may take the form of, for example, the second end 518 being sewn in place. Thus, the ejection strap 510 forms a part of the illustrated pouch assembly 100; however in some alternative examples the ejection strap 510 is not included as a part of the assembly, and instead the tactical radio 204 is moved out of the locked position within in the pouch body 110 in some other manner in which an ejection strap is not employed.

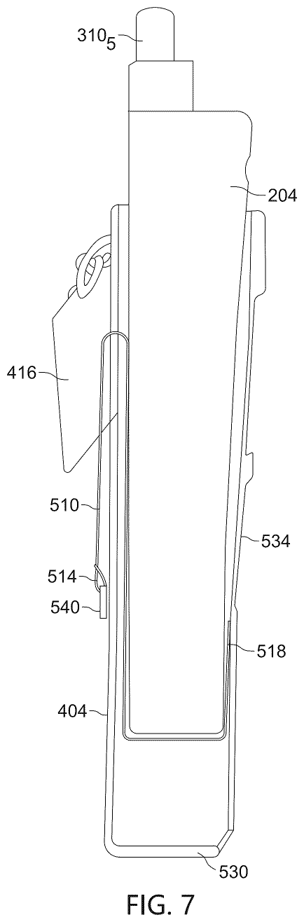

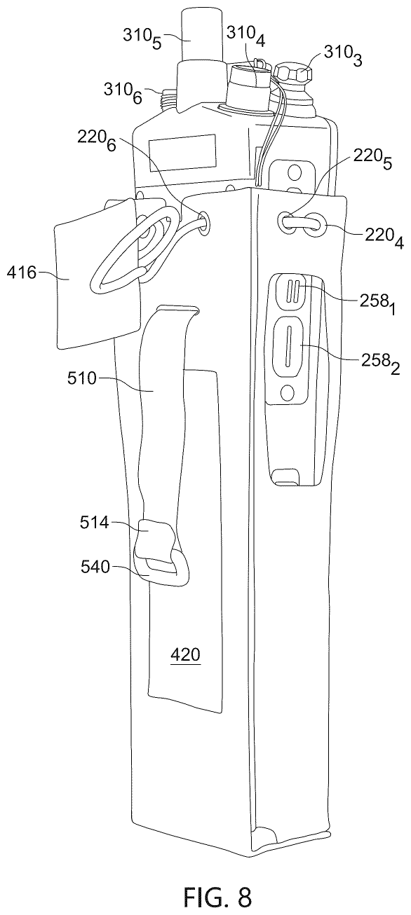

It will be noted that, in FIG. 6, the tactical radio 204 is shown fully inserted into a locked position inside the pouch body 110. Also, the tactical radio 204 is resting on a portion of the ejection strap 510 immediately above the bottom end 530 of the pouch body 110. The ejection strap 510 is configured to be pulled by a D-ring 540, attached to the free end (i.e. the first end 514) of the ejection strap 510, being in turn pulled by finger(s) of a person, to force the tactical radio 204 upwardly relative to the pouch body 110, and move the tactical radio 204 from the fully inserted state (i.e. as shown in FIG. 6) to the partly inserted state as shown in FIGS. 7 and 8. In the partly inserted state illustrated in FIGS. 7 and 8, where the tactical radio 204 is in the unlocked position, the previously mentioned portion of the ejection strap 510 immediately above the bottom end 530 of the pouch body 110 moves upwardly in tandem with the upward movement of the tactical radio 204. It will be understood that the tactical radio 204 is pushed upward by a force transmitted through the ejection strap 510 (noting that the originating force is from the pulling action on the ejection strap 510).

The above-described force transmitted through the ejection strap 510 is sufficient to overcome the locking resistance of the four cord sections 316₁-316₄ which otherwise retains the tactical radio 204 in the pouch body 110. Also, it will be noted that a portion of the ejection strap 510 located outside of the pouch body 110 is extended in length in the unlocked position as compared to the locked position of the tactical radio 204.

Those skilled in the art will appreciate that although a D-ring is shown attached to the first end 514 in the illustrated example embodiment, other suitable types of alternative finger grips are also contemplated (for example, a differently shaped ring, a T-shaped grip, etcetera). Also, prior to proceeding with the pulling of the D-ring 540 as described above, the adjustable pad 416 can be detached from the loop portion 420 (as shown in FIGS. 7 and 8) to minimize tension in the tensionable cord 408.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, the terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A pouch assembly for protectively covering a handheld radio, the pouch assembly comprising:
a pouch body having a closed bottom end, an open top end and a sidewall region having a length, as measured from the bottom end to the top end between which the sidewall region extends, that is greater than a corresponding length of the handheld radio, and a plurality of holes being defined in the pouch body at a respective plurality of locations within the sidewall region, each hole of the plurality of holes being situated in an upper portion of the sidewall region corresponding to being below the open top end and above a partial height boundary of the sidewall region that is a vertical distance, equaling a length of the handheld radio, away from the bottom end of the pouch body; and
a tensionable cord that extends through each of the holes and comprises a plurality of cord sections that include first, second, third and fourth cord sections with each of the first, second, third and fourth cord sections configured to engage over a respective one of four corners of a top end of the handheld radio when the handheld radio is fully inserted into the pouch body.

2. The pouch assembly of claim 1 further comprising a plurality of eyelets, each eyelet of the plurality of eyelets being attached to the pouch body at a respective one of the plurality of holes.

3. The pouch assembly of claim 1 further comprising a hook-and-loop fastener that includes a hook portion, on an adjustable pad, to which ends of the tensionable cord are attached, and a loop portion attached on a back portion of the sidewall region, and the adjustable pad being mateable to the loop portion over a range of different distances from the top end according to desired tension of the tensionable cord.

4. The pouch assembly of claim 3 wherein the loop portion is elongated, relative to a corresponding dimension of the hook portion, to permit the range of different distances and associated variance of tension of the tensionable cord.

5. The pouch assembly of claim 1 wherein the pouch body is a rayon fabric pouch body.

6. The pouch assembly of claim 1 wherein the tensionable cord is a shock cord.

7. The pouch assembly of claim 1 wherein the plurality of holes includes eight holes, and each of the first, second, third and fourth cord sections extend, inside the pouch body, between a different respective pair of the eight holes.

8. The pouch assembly of claim 7 wherein the sidewall region is divided into a front portion within which a first two of the eight holes are located, a back portion within which a second two of the eight holes are located, a first side edge portion within which a third two of the eight holes are located, and a second side edge portion within which a fourth two of the eight holes are located.

9. A pouch assembly for protectively covering a handheld radio, the pouch assembly comprising:
a pouch body having a closed bottom end, an open top end and a sidewall region, and the sidewall region being divided into a front portion, a first side edge portion, a second side edge portion, and a back portion defining a strap slot, and the pouch body being configured to surround the handheld radio in either a fully inserted state or a partly inserted state; and
an ejection strap having first and second ends, the ejection strap disposed in the pouch body such that the ejection strap extends from the first end located outside of the pouch body, into an interior of the pouch body, via the strap slot, and down part of the back portion, across the bottom end to attach to the pouch body by way of the second end of the ejection strap,
wherein when the handheld radio is in the fully inserted state resting on a portion of the ejection strap immediately above the bottom end of the pouch body, the ejection strap is configured to be pulled by the first end to force the handheld radio upwardly relative to the pouch body and move the handheld radio from the fully inserted state to the partly inserted state.

10. The pouch assembly of claim 9 wherein the ejection strap includes a finger grip attached to the first end of the ejection strap.

11. The pouch assembly of claim 9 further comprising a tensionable cord that extends through a plurality of holes defined in the sidewall region, and the tensionable cord comprising a plurality of cord sections that include first, second, third and fourth cord sections with each of the first, second, third and fourth cord sections configured to engage over a respective one of four corners of a top end of the handheld radio when the handheld radio is in the fully inserted state.

12. The pouch assembly of claim 11 wherein, relative to the open top end, the top end of the handheld radio is below all of the first, second, third and fourth cord sections when the handheld radio is in the fully inserted state.

13. The pouch assembly of claim 11 wherein the ejection strap is configured to be pulled with sufficient force to overcome a locking resistance of the first, second, third and fourth cord sections in order to move the handheld radio from the fully inserted state to the partly inserted state.

14. The pouch assembly of claim 13 wherein, relative to the open top end, the top end of the handheld radio is below all of the first, second, third and fourth cord sections when the handheld radio is in the fully inserted state.

15. The pouch assembly of claim 14 wherein, relative to the open top end, the top end of the handheld radio is above all of the first, second, third and fourth cord sections when the handheld radio is in the partly inserted state.

16. The pouch assembly of claim 9 wherein in addition to the ejection strap extending across the bottom end, the ejection strap also extends upwardly, part-way along the front portion, to attach via the second end to the front portion of the sidewall region.
